(19) United States
(12) Patent Application Publication
(10) Pub. No.: US 2024/0320926 A1
(43) Pub. Date: Sep. 26, 2024

(54) MIXED REALITY AVATAR EYE INPAINTING BASED ON USER SPEECH

(71) Applicant: INTERNATIONAL BUSINESS MACHINES CORPORATION, ARMONK, NY (US)

(72) Inventors: Yi Nong Xin, Hefei (CN); Li Wang, Shanghai (CN); Jing Chen, Chengzhong Garden (CN); Mo Han Bai, Shanghai (CN); Xiao Feng Ji, Shanghai (CN)

(21) Appl. No.: 18/187,328

(22) Filed: Mar. 21, 2023

(51) Int. Cl. G06T 19/00; G06T 17/20

(52) U.S. Cl. CPC G06T 19/006; G06T 17/20; G06T 2207/30201

(57) ABSTRACT

According to one embodiment, a method, computer system, and computer program product for mixed reality is provided. The present invention may include receiving one or more 3D non-eye landmarks of a user; receiving at least one voice audio of the user; using random noise sampled with a unit normal distribution as one or more noised 3D eye landmarks for the user; inputting the received one or more 3D non-eye landmarks of the user, the at least one voice audio of the user, and the one or more noised 3D eye landmarks for the user, into a trained eye landmark generative model; generating one or more 3D eye landmarks for the user using the trained eye landmark generative model; performing iterative refinement of the one or more generated 3D eye landmarks using the trained eye landmark generative model; and rendering the user's generated face model using a formed 3D face mesh.

### BACKGROUND

The present invention relates, generally, to the field of computing, and more particularly to mixed reality.

Mixed reality (MR) is a technology that uses software to overlay virtual information onto a virtual environment to provide a person with an authentic virtual experience. Mixed reality is built on the convergence of virtual reality (VR) and augmented reality (AR), which allows for a web of networked immersive experiences and social in a multiuser persistent platform. Currently, mixed reality can capture and estimate the movements of a user's eye regions based on a face mesh of the user's face obtained through the use of an external depth camera. However, it may be common for a user's eye regions to be partially or fully occluded, and thus, not able to be accurately captured and depicted in a virtual environment. Therefore, in order for mixed reality to provide a user with as immersive of an experience as possible, a method and system by which a user's eye regions are both accurately captured and displayed in a virtual environment, are needed. Thus, an improvement in mixed reality has the potential to benefit the overall user experience by providing the user with a truly immersive experience.

### SUMMARY

According to one embodiment, a method, computer system, and computer program product for mixed reality is provided. The present invention may include receiving one or more 3D non-eye landmarks of a user; receiving at least one voice audio of the user; using random noise sampled with a unit normal distribution as one or more noised 3D eye landmarks for the user; inputting the received one or more 3D non-eye landmarks of the user, the at least one voice audio of the user, and the one or more noised 3D eye landmarks for the user, into a trained eye landmark generative model; generating one or more 3D eye landmarks for the user using the trained eye landmark generative model; performing iterative refinement of the one or more generated 3D eye landmarks using the trained eye landmark generative model; and rendering the user's generated face model using a formed 3D face mesh.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an exemplary application invention environment according to at least one embodiment;

FIG. 3 is an operational flowchart illustrating an improved mixed reality eye inpainting determination process according to at least one embodiment;

FIG. 4 is a system diagram illustrating an exemplary program environment of an implementation of a mixed reality eye inpainting determination process according to at least one embodiment; and

FIG. 5 depicts a visual representation of an eye landmark inpainting process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

In mixed reality, a virtual model of a person can be captured and displayed in the virtual world to mimic the person in the real world. Mixed reality can generate a virtual model of a person based on meshes obtained by an external depth camera. However, cases exist in which a user's eye regions are partially or fully occluded, such as when wearing sunglasses. In order for a truly immersive mixed reality experience, a detailed and accurate display of a user's eye regions in a virtual environment is needed. Therefore, the optimization of mixed reality may be limited by the lack of a detailed and accurate display of a user's eye regions. As a result, users are not provided with an accurate experience, as the quality of their virtual reality is hindered by an inaccurate display of themselves.

One way in which current methods attempt to address problems with accurately displaying a user's eye regions in a virtual world is by obtaining a user's real-time 3D face mesh through the use of an external depth camera facing the frontal face of the user to drive the user's pre-made virtual face model. Obtaining a user's real-time 3D face mesh by capturing the frontal face of the user may provide acceptable results when a person's entire face is visible. However, one of the deficiencies of the current method is that the method is inadequate when a user's eye regions are partially or fully occluded. It is important that a user's virtual model displays the user's eye regions in a more natural and complete state in a virtual environment. Thus, an improvement in mixed reality has the potential to benefit the overall user experience by providing the user with a truly immersive experience.

The present invention has the capacity to improve mixed reality by accurately displaying the eye regions of a user in a virtual environment. The program can accurately capture the eye regions of a user's face based on using a trained eye landmark generative model and display the eye regions, along with the rest of the user's face, in the virtual environment using a formed 3D face mesh of the user's face model. This improvement in mixed reality can be accomplished by implementing a system that receives one or more 3D non-eye landmarks of a user, receives at least one voice audio of the user, uses random noise sampled with a unit normal distribution as one or more noised 3D eye landmarks for the user, inputs the received one or more 3D non-eye landmarks of the user, the at least one voice audio of the user, and the one or more noised 3D eye landmarks for the user, into a trained eye landmark generative model, generates one or more 3D eye landmarks for the user using the trained eye landmark generative model, performs iterative refinement of the one or more generated 3D eye landmarks using the trained eye landmark generative model, and renders the user's generated face model using a formed 3D face mesh.

In some embodiments of the invention, the mixed reality eye inpainting determination program, herein referred to as “the program”, can receive 3D non-eye landmarks and user voice audio. A user's non-eye landmarks may comprise the regions of a person's face excluding the eye regions of the user's face. The program can receive the non-eye landmarks of a user, which are captured by the use of an MR device and/or one or more IoT devices, such as cameras. In some embodiments of the invention, the program may also use a computer vision system to capture a user's 3D non-eye landmarks. The program can process eye and non-eye landmarks by using joint recognition algorithms. Eye landmarks and non-eye landmarks may together be referred to as face landmarks. User voice audios may comprise audio spoken by the user. User voice audios may be uploaded to the program. The program can detect that a user starts speaking at timepoint T₀ in a mixed reality environment. The program can obtain the data at each preset sampling interval comprising the voice clip spoken by the user during the current sampling interval. Additionally, the program can obtain the 3D face mesh of the user's realistic 3D face model presented at the current sampling timepoint Tₙ, n=1, 2, 3, etc. The 3D face mesh can comprise M non-eye landmarks and N eye landmarks. A user's eye landmarks may comprise the eye regions of a person's face.

The program can use random noise sampled with a unit normal distribution as noised 3D eye landmarks. The program can assign each eye landmark from the user's captured face with random noises as its noised 3D eye landmark.

The program can input the noised 3D eye landmarks, 3D non-eye landmarks, and user voice audio into a trained eye landmark generative model. The eye landmark generative model can comprise a backbone network composed of L MLP (multilayer perceptron)-Mixer layers and a linear projection layer. Additionally, the eye landmark generative model can comprise a standard Transformer encoder. The Transformer encoder can comprise L attention layers, eight attention heads, five hundred and twelve model dimensions, and five hundred and twelve hidden dimensions. The program can train an eye landmark generative model. The program can train an eye landmark generative model by building training datasets. Training datasets may be built by collecting a large number of videos, which can be uploaded to the program. The program can convert the corresponding audio clip of a video to text using Speech-To-Text (STT). For each played video, the program can obtain the 3D face landmarks of the human in the video at every preset sampling timepoint, using 3D face landmark recognition technology such as MediaPipe Face Mesh. The program can convert the waveform of the corresponding audio clip during every sampling interval to a spectrogram. The program can divide the spectrogram into K patches of the same size to form a sequence of spectrogram patches. The program can save the 3D face landmarks obtained at each sampling timepoint, and the corresponding spectrogram-patch sequence as one set of training data in the training dataset.

The program can perform a denoising diffusion processing during the training of the eye landmark generative model. The denoising diffusion processing may comprise randomly selecting training data, such as a face-landmark set of size M+N and a paired sequence of K spectrogram patches, from the training dataset, and selecting a positive integer number [1, T] at random as the current diffusion time step t. Furthermore, the denoising diffusion processing comprises adding random Gaussian noise, based on the value of the current diffusion time step t, to each coordinate value, XYZ, respectively, of the eye landmarks. The program can linearly project the current diffusion time step t, K spectrogram patches, M non-eye landmarks and N noised eye landmarks to token embeddings, in a preset order, to obtain an input sequence. The input sequence can comprise each token embedding summed with its corresponding position embedding. The program can feed the input sequence to the Transformer encoder. The program can predict and obtain the unnoised eye landmark(s) corresponding to each input noised eye landmark at the output side of the MLP. Additionally, performing the denoising diffusion processing may also comprise training the eye landmark generative model to predict the unnoised eye landmarks zᵢ directly, and using a mean-squared error loss on the prediction. The program can use backpropagation to update the parameters of the eye landmark generative model.

The program can generate 3D eye landmarks using the eye landmark generative model, conditioned on the related non-eye landmarks and a voice clip. The program can input all the eye landmarks of a user's face, comprising the received 3D non-eye landmarks and the noised 3D eye landmarks, in a preset order, and can sample the eye landmarks after at most T diffusion time steps. At a sampling timepoint Tₙ, the program can convert the audio waveform of the obtained voice clip to a spectrogram. The program can divide the spectrogram into K patches of the same size. The program can feed the initial diffusion time step t (t=T, where T is the maximum diffusion time step), K spectrogram patches, M non-eye landmarks, and N noised eye landmarks to the trained eye landmark generative model, sequentially, in a preset order. The trained eye landmark generative model can generate N eye landmarks for the diffusion time step T. At the subsequent diffusion time steps (from T−1 to 1), the program feeds the trained eye landmark generative model the next diffusion time steps t, K original spectrogram patches, M original non-eye landmarks, and the N eye landmarks generated at the previous diffusion time step, in order to generate N eye landmarks for the diffusion time steps T−1 to 1. The N eye landmarks generated at the last diffusion time step (t=1) can be considered the final sampling results for the 3D eye landmarks.

The program can perform an iterative refinement of the generated 3D eye landmarks using the trained eye landmark generative model. Through the iterative refinement process, the program can obtain the final N eye landmarks at the sampling timepoint Tₙ. Specifically, the program can input a sequence into the eye landmark generative model comprising a diffusion time step t, a sequence of K spectrogram patches that corresponds to a voice clip, wherein the spectrogram patches are sorted in ascending order according to a pre-assigned patch index, a sequence of M non-eye landmarks that are sorted in ascending order according to a landmark index, and a sequence of N noised eye landmarks that are sorted in ascending order according to a landmark index. The program can linearly project each diffusion time step t, represented as a T-dimensional one-hot encoded embedding, where T is the maximum diffusion time step, to a five-hundred and twelve-dimensional token embedding through a linear projection layer. The program can linearly project each spectrogram patch to a five-hundred and twelve-dimensional token embedding through a per-patch linear projection layer. Each 3D face landmark can be considered as a 3-dimensional vector. The program can linearly project each 3D face landmark to a five-hundred and twelve-dimensional token embedding through a per-landmark linear projection layer. Each final input embedding can be the sum of a token embedding and a corresponding five-hundred and twelve-dimensional position embedding. The Transformer encoder can take in the input embeddings. The program can pass each output feature vector from the Transformer encoder which corresponds to an input eye landmark, through an MLP (multilayer perceptron). The output of the MLP can be a 3-dimensional vector that represents a generated 3D eye landmark. The three dimensions of a vector can represent the three-dimensional coordinate values, respectively.

The program can render the user's face model using a formed 3D face mesh. The program can form a 3D face mesh by combining the generated 3D eye landmarks and the received 3D non-eye landmarks together to form a 3D face mesh. The program can render the generated 3D eye landmark(s) produced by the trained eye landmark generative model and the received non-eye landmark(s). The program can render the user's face model using the formed 3D face mesh to obtain a realistic 3D face model for the user's avatar in a mixed reality (MR) simulated environment.

The program can render a mixed reality (MR) simulated environment. The MR simulated environment, herein referred to as “the MR environment”, may be a hybrid environment comprising both physical and virtual elements. The MR environment may comprise a hybrid physical/virtual world in which one or more users may enter, see, move around in, interact with, etc. through the medium of a MR device. The users in the MR environment may be able to see and/or interact with the same virtual objects and virtual elements and may interact with virtual representations of each other. The MR environment may comprise AR environments wherein generated images, sounds, haptic feedback, and other sensations are integrated into a real-world environment. The MR environment may comprise virtual reality (VR) environments that fully replace the physical environment with virtual elements, such that a user experiencing a VR environment cannot see any objects or elements of the physical world; however, the VR environments are anchored to real-world locations, such that the movement of the users, virtual objects, virtual environmental effects and elements all occur relative to the corresponding locations in the physical environment. The program can track the movements of the users. IoT devices, such as cameras and/or sensors, can be used to detect what actions are being performed by the users and the movement patterns of the users. For example, wearable IoT devices or movement detection sensors may be used.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to receive one or more 3D non-eye landmarks of a user, receive at least one voice audio of the user, use random noise sampled with a unit normal distribution as one or more noised 3D eye landmarks for the user, input the received one or more 3D non-eye landmarks of the user, the at least one voice audio of the user, and the one or more noised 3D eye landmarks for the user, into a trained eye landmark generative model, generate one or more 3D eye landmarks for the user using the trained eye landmark generative model, perform iterative refinement of the one or more generated 3D eye landmarks using the trained eye landmark generative model, and render the user's generated face model using a formed 3D face mesh.

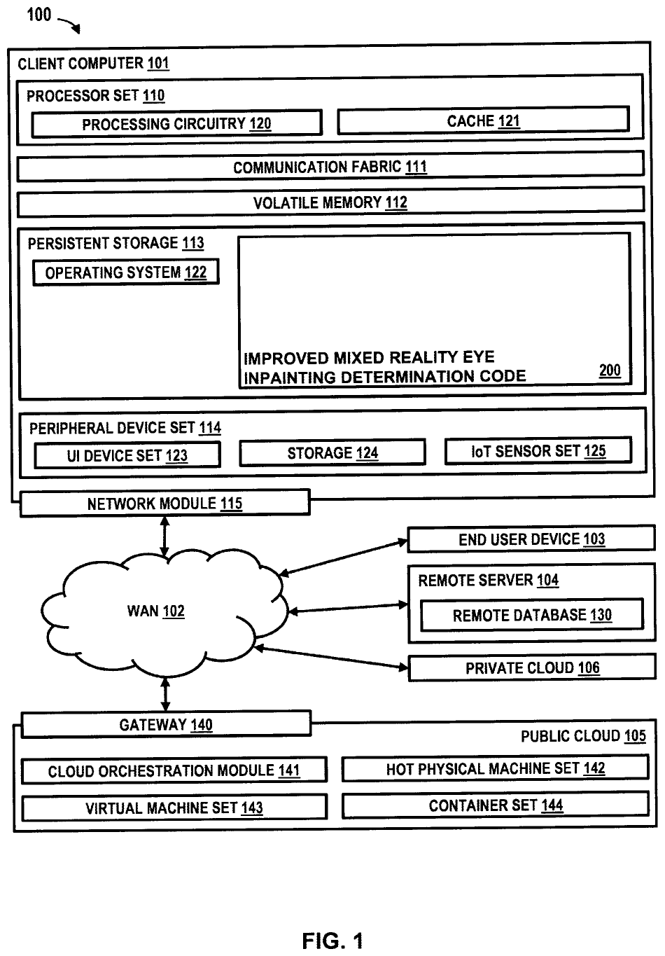

Referring to FIG. 1, an exemplary networked computer environment 100 is depicted, according to at least one embodiment. Computing environment 100 contains an example of an environment for the execution of at least some of the computer code involved in performing the inventive methods, such as improved mixed reality eye inpainting determination code 200. In addition to code block 200 computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

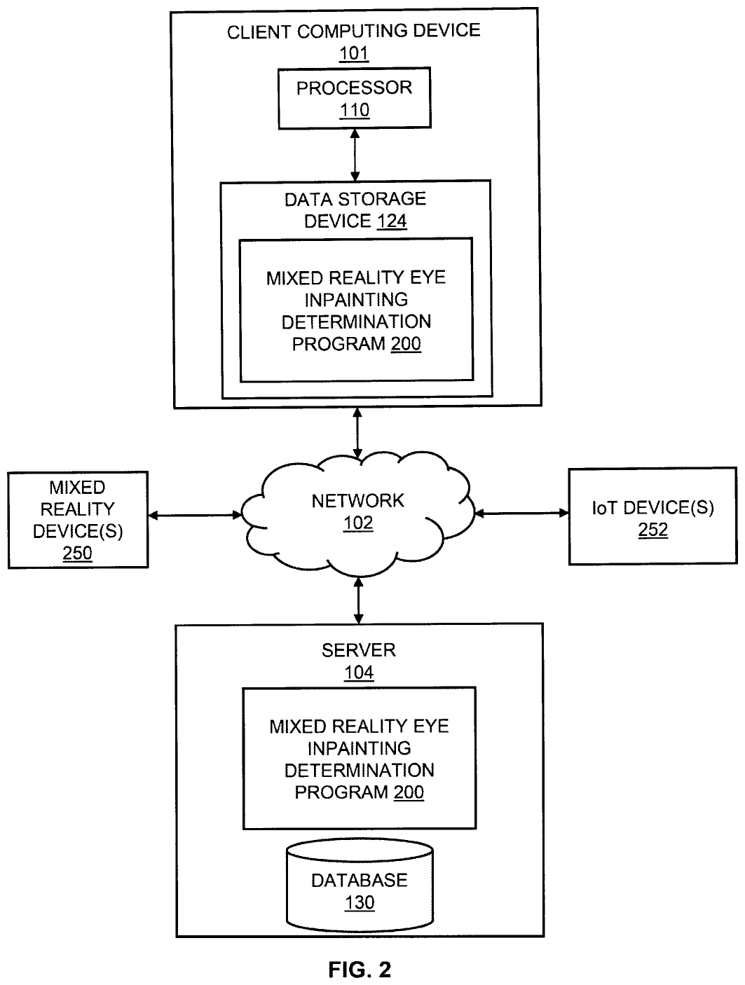

Referring to FIG. 2, an exemplary application environment is depicted, according to at least one embodiment. FIG. 2 may include client computing device 101 and a remote server 104 interconnected via a communication network 102. According to at least one implementation, FIG. 2 may include a plurality of client computing devices 101 and remote servers 104, of which only one of each is shown for illustrative brevity. It may be appreciated that FIG. 2 provides only an illustration of one implementation and does not imply any limitations with regard to the environments in which different embodiments may be implemented. Many modifications to the depicted environments may be made based on design and implementation requirements.

Client computing device 101 may include a processor 110 and a data storage device 124 that is enabled to host and run a mixed reality eye inpainting determination program 200 and communicate with the remote server 104 via the communication network 102, in accordance with one embodiment of the invention.

The remote server computer 104 may be a laptop computer, netbook computer, personal computer (PC), a desktop computer, or any programmable electronic device or any network of programmable electronic devices capable of hosting and running a mixed reality eye inpainting determination program 200 and a database 130 and communicating with the client computing device 101 via the communication network 102, in accordance with embodiments of the invention. The remote server 104 may also operate in a cloud computing service model, such as Software as a Service (SaaS), Platform as a Service (PaaS), or Infrastructure as a Service (IaaS). The remote server 104 may also be located in a cloud computing deployment model, such as a private cloud, community cloud, public cloud, or hybrid cloud.

The database 130 may be a digital repository capable of data storage and data retrieval. The database 130 can be present in the remote server 104 and/or any other location in the network 102. The database 130 can store 3D face models and the data related to the 3D face models. Additionally, the database 130 can comprise the trained eye landmark generative model and the training data used to train the model. The database 130 can comprise a knowledge corpus. The knowledge corpus may comprise information relating to previously used MR devices 250 and IoT devices 252. Additionally, the knowledge corpus can comprise information relating to the MR devices 250, and IoT devices 252. The knowledge corpus may be updated based on the MR devices 250 and IoT devices 252 used and the continuous tracking of a user's face. Also, the knowledge corpus may comprise information relating to object recognition.

Mixed reality (MR) device(s) 250 may be any device or combination of devices enabled to record world information that the MR module 404 may overlay with computer-generated perceptual elements to create a MR environment. The MR device(s) 250 can record the actions, position, movements, etc. of a user, to track the user's movement within and interactions with the MR environment. The MR device 250 can display a MR simulated environment to a user and allow the user to interact with the MR environment. The MR device 250 can be a headset. Also, the MR device 250 can comprise a head-mounted display (HMD). Additionally, the MR device 250 may be equipped with or comprise a number of sensors, such as a camera, microphone, and accelerometer, and these sensors may be equipped with or comprise a number of user interface devices such as touchscreens, speakers, etc.

IoT device(s) 252 may be any device capable of continuously capturing a user's face while static or in movement. The IoT device(s) 252 can comprise cameras, such as any device capable of recording visual images in the form of photographs, films, or video signals, such as a physical or virtual camera, and/or sensors, such as accelerometers, gyroscopes, magnetometers, proximity sensors, pressure sensors, etc.

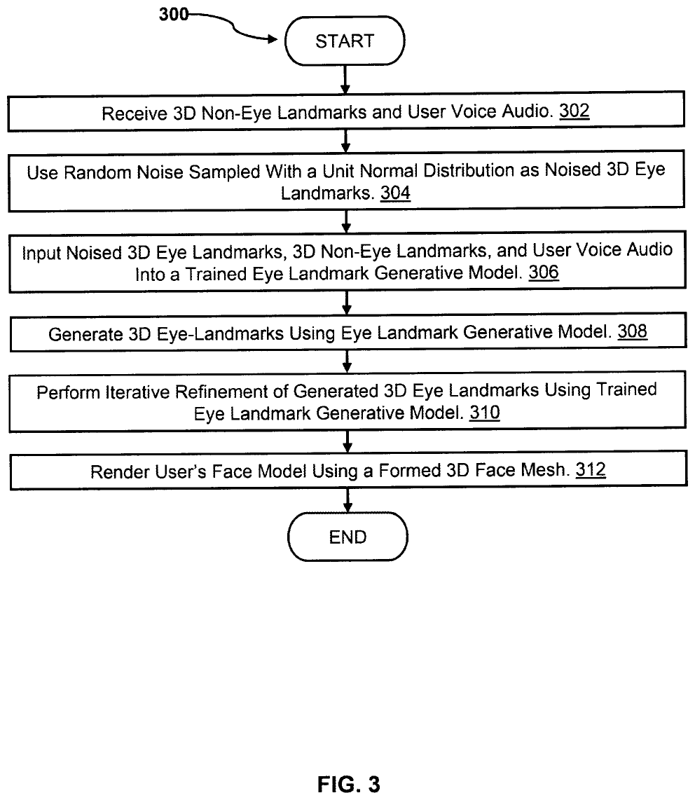

According to the present embodiment, the mixed reality eye inpainting determination program 200 herein referred to as “the program”, may be a program capable of receiving 3D non-eye landmarks and user voice audio, using random noise sampled with a unit normal distribution as noised 3D eye landmarks, inputting the noised 3D eye landmarks, 3D non-eye landmarks, and user voice audio into a trained eye landmark generative model, generating 3D eye landmarks using the eye landmark generative model, performing an iterative refinement of the generated 3D eye landmarks using the trained eye landmark generative model, and rendering the user's face model using a formed 3D face mesh. The program 200 may be located on client computing device 101 or remote server 104 or on any other device located within network 102. Furthermore, the program 200 may be distributed in its operation over multiple devices, such as client computing device 101 and remote server 104. The mixed reality eye inpainting determination method is explained in further detail below with respect to FIG. 3.

Referring now to FIG. 3, an operational flowchart illustrating a mixed reality eye inpainting determination process 300 is depicted according to at least one embodiment. At 302, the program 200 receives 3D non-eye landmarks and user voice audio. A user's non-eye landmarks may comprise the regions of a person's face excluding the eye regions of the user's face. The program 200 can receive the non-eye landmarks of a user, which are captured by the use of an MR device 250 and/or one or more IoT devices 252, such as cameras. In some embodiments of the invention, the program 200 may use a computer vision system to capture a user's 3D non-eye landmarks. The program 200 can process eye landmarks and non-eye landmarks by using joint recognition algorithms. Eye landmarks and non-eye landmarks may together be referred to as face landmarks. User voice audios may comprise audio spoken by the user. User voice audios may be uploaded to the program 200. The program 200 can detect that a user starts speaking at timepoint T₀ in a mixed reality environment. The program 200 can obtain the data at each preset sampling interval comprising the voice clip spoken by the user during the current sampling interval. Additionally, the program 200 can obtain the 3D face mesh of the user's realistic 3D face model presented at the current sampling timepoint Tₙ, n=1, 2, 3, etc. The 3D face mesh can comprise M non-eye landmarks and N eye landmarks. A user's eye landmarks may comprise the eye regions of a person's face.

At 304, the program 200 uses random noise sampled with a unit normal distribution as noised 3D eye landmarks. The program 200 can assign each eye landmark from the user's captured face with random noises as its noised 3D eye landmark.

At 306, the program 200 inputs the eye landmarks, 3D non-eye landmarks, and user voice audio into a trained eye landmark generative model. The eye landmark generative model can comprise a backbone network composed of L MLP (multilayer perceptron)-Mixer layers and a linear projection layer. Additionally, the eye landmark generative model can comprise a standard Transformer encoder. The Transformer encoder can comprise L attention layers, eight attention heads, five hundred and twelve model dimensions, and five hundred and twelve hidden dimensions. The program 200 can train an eye landmark generative model. The program 200 can train an eye landmark generative model by building training datasets. Training datasets may be built by collecting a large number of videos, which can be uploaded to the program 200. The program 200 can play every video comprising only one human and wherein the corresponding audio clip of a video only comprises voice content spoken by the one human. The program 200 can convert the corresponding audio clip of a video to text using Speech-To-Text (STT). For each played video, the program 200 can obtain the 3D face landmarks of the human in the video at every preset sampling timepoint, using 3D face landmark recognition technology such as MediaPipe Face Mesh. The program 200 can convert the waveform of the corresponding audio clip during every sampling interval to a spectrogram. The program 200 can divide the spectrogram into K patches of the same size to form a sequence of spectrogram patches. The program 200 can save the 3D face landmarks obtained at each sampling timepoint, and the corresponding spectrogram-patch sequence as one set of training data in the training dataset.

The program 200 can perform a denoising diffusion processing during the training of the eye landmark generative model. The denoising diffusion processing may comprise randomly selecting training data, such as a face-landmark set of size M+N and a paired sequence of K spectrogram patches, from the training dataset, and selecting a positive integer number [1, T] at random as the current diffusion time step t. Furthermore, the denoising diffusion processing comprises adding random Gaussian noise, based on the value of the current diffusion time step t, to each coordinate value, XYZ, respectively, of the eye landmarks. The random Gaussian noises can be calculated using the following formula:

$$q ( {x}_{t} \vert {x}_{0} ) = ( {x}_{t} ; \sqrt{{\overline{α}}_{t}} {x}_{0} , ( 1 - {\overline{α}}_{t} ) I )$$

αₜ:=1−βₜ; α̅ₜ:=Πₛ₌₁^{t}αₛ; βₜ can be a linear schedule (e.g., from β₁=10⁻⁴ to β_{T}=0.02); x₀ can be an original coordinate value; and xₜ can be a noised coordinate value with the added Gaussian noise corresponding to the specific diffusion time step t. The program 200 can linearly project the current diffusion time step t, K spectrogram patches, M non-eye landmarks and N noised eye landmarks to token embeddings, in a preset order, to obtain an input sequence. The input sequence can comprise each token embedding summed with its corresponding position embedding. The program 200 can feed the input sequence to the Transformer encoder. The program 200 can predict and obtain the unnoised eye landmark(s) corresponding to each input noised eye landmark at the output side of the MLP. Additionally, performing the denoising diffusion processing may also comprise training the eye landmark generative model to predict the unnoised eye landmarks zᵢ directly, and using a mean-squared error loss on the prediction using the following formula:

$$L = {t \sim [ 1 , T ] , {z}_{i}^{( t )} \sim {q}_{t}}_{} [ {‖ {f}_{θ} ( {z}_{i}^{( t )} , t ) - {z}_{i} ‖}^{2} ]$$

zᵢ^{(t)} can be the noised eye landmarks, with the noise corresponding to the specific diffusion time step t; zᵢ can be the original (unnoised) non-eye landmarks; and f_{θ}(·) can be the prediction from the eye landmark generative model. The program 200 can use backpropagation to update the parameters of the eye landmark generative model.

At 308, the program 200 generates 3D eye landmarks using the eye landmark generative model, conditioned on the related non-eye landmarks and a voice clip. The program 200 can input all the eye landmarks of a user's face, comprising the received 3D non-eye landmarks and the noised 3D eye landmarks, in a preset order, and can sample the eye landmarks after at most T diffusion time steps. At a sampling timepoint Tₙ, the program 200 can convert the audio waveform of the obtained voice clip to a spectrogram. The program 200 can divide the spectrogram into K patches of the same size. The program 200 can feed the initial diffusion time step t (t=T, where T is the maximum diffusion time step, for example, T=1000), K spectrogram patches, M non-eye landmarks, and N noised eye landmarks to the trained eye landmark generative model, sequentially, in a preset order. The trained eye landmark generative model can generate N eye landmarks for the diffusion time step T. At the subsequent diffusion time steps (from T−1 to 1), the program 200 feeds the trained eye landmark generative model the next diffusion time steps t, K original spectrogram patches, M original non-eye landmarks, and the N eye landmarks generated at the previous diffusion time step, in order to generate N eye landmarks for the diffusion time steps T−1 to 1. The N eye landmarks generated at the last diffusion time step (t=1) can be considered the final sampling results for the 3D eye landmarks.

At 310, the program 200 performs an iterative refinement of the generated 3D eye landmarks using the trained eye landmark generative model. Through the iterative refinement process, the program 200 can obtain the final N eye landmarks at the sampling timepoint Tₙ. Specifically, the program 200 can input a sequence into the eye landmark generative model comprising a diffusion time step t, a sequence of K spectrogram patches that corresponds to a voice clip, wherein the spectrogram patches are sorted in ascending order according to a pre-assigned patch index, a sequence of M non-eye landmarks that are sorted in ascending order according to a landmark index, and a sequence of N noised eye landmarks that are sorted in ascending order according to a landmark index. The program 200 can linearly project each diffusion time step t, represented as a T-dimensional one-hot encoded embedding, where T is the maximum diffusion time step, to a five-hundred and twelve-dimensional token embedding through a linear projection layer. The program 200 can linearly project each spectrogram patch to a five-hundred and twelve-dimensional token embedding through a per-patch linear projection layer. Each 3D face landmark can be considered as a 3-dimensional vector. The program 200 can linearly project each 3D face landmark to a five-hundred and twelve-dimensional token embedding through a per-landmark linear projection layer. Each final input embedding can be the sum of a token embedding and a corresponding five-hundred and twelve-dimensional position embedding. The Transformer encoder can take in the input embeddings. The program 200 can pass each output feature vector from the Transformer encoder which corresponds to an input eye landmark, through an MLP (multilayer perceptron). The output of the MLP can be a 3-dimensional vector that represents a generated 3D eye landmark. The three dimensions of a vector can represent the three-dimensional coordinate values, respectively.

At 312, the program 200 renders the user's face model using a formed 3D face mesh. The program 200 can form a 3D face mesh by combining the generated 3D eye landmarks and the original 3D non-eye landmarks together to form a 3D face mesh. The program 200 can render the generated 3D eye landmark(s) produced by the trained eye landmark generative model and the received non-eye landmark(s). The program 200 can render the user's face model using the formed 3D face mesh to obtain a realistic 3D face model for the user's avatar in a mixed reality (MR) simulated environment. The program 200 can render a mixed reality (MR) simulated environment. The MR simulated environment, herein referred to as “the MR environment”, may be a hybrid environment comprising both physical and virtual elements. The MR environment may comprise a hybrid physical/virtual world in which one or more users may enter, see, move around in, interact with, etc. through the medium of a MR device. The users in the MR environment may be able to see and/or interact with the same virtual objects and virtual elements and may interact with virtual representations of each other. The MR environment may comprise MR environments wherein generated images, sounds, haptic feedback, and other sensations are integrated into a real-world environment. The MR environment may comprise virtual reality (VR) environments that fully replace the physical environment with virtual elements, such that a user experiencing a VR environment cannot see any objects or elements of the physical world; however, the VR environments are anchored to real-world locations, such that the movement of the users, virtual objects, virtual environmental effects and elements all occur relative to the corresponding locations in the physical environment.

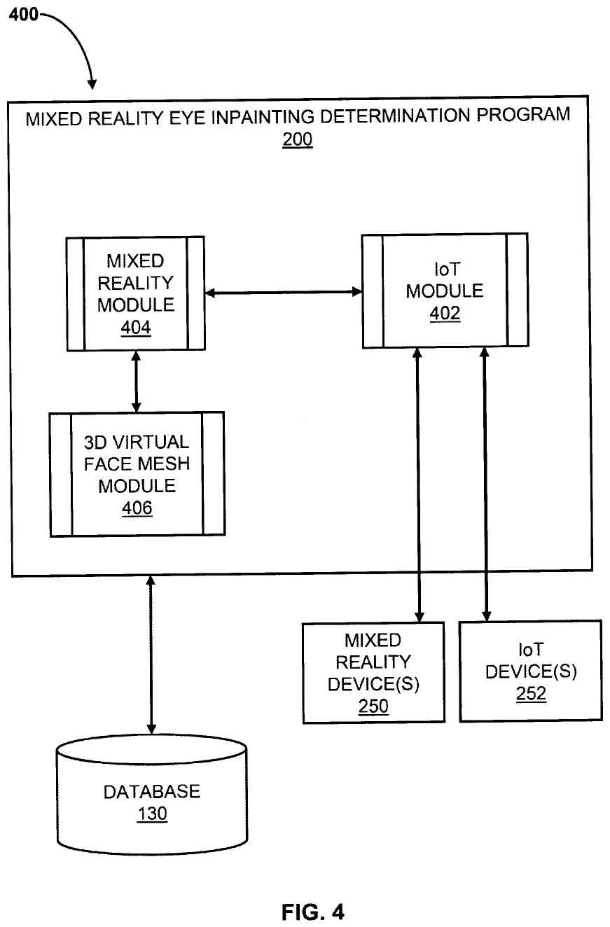

Referring now to FIG. 4, a system diagram illustrating an exemplary program environment 400 of an implementation of a mixed reality eye inpainting determination process 300 is depicted according to at least one embodiment. Here, the program 200 comprises an IoT module 402, a mixed reality module 404, and a 3D virtual face mesh module 406. The exemplary program environment 400 details the interactions between the IoT module 402 and the mixed reality module 404, and the mixed reality module 404 and the 3D virtual face mesh module 406. Additionally, the exemplary program environment 400 details the interactions between the mixed reality eye inpainting determination program 200 and the database 130, the IoT module 402 and the mixed reality device(s) 250, and the IoT module 402 and the IoT device(s) 252.

The IoT module 402 may be used to communicate with the mixed reality device(s) 250 and the IoT device(s) 252. The mixed reality module 404 may be used to display the mixed reality environment and the mixed reality objects. The 3D virtual face mesh module 406 may be used to render the generated 3D eye landmarks of the user's face and the user's face model in the mixed reality environment.

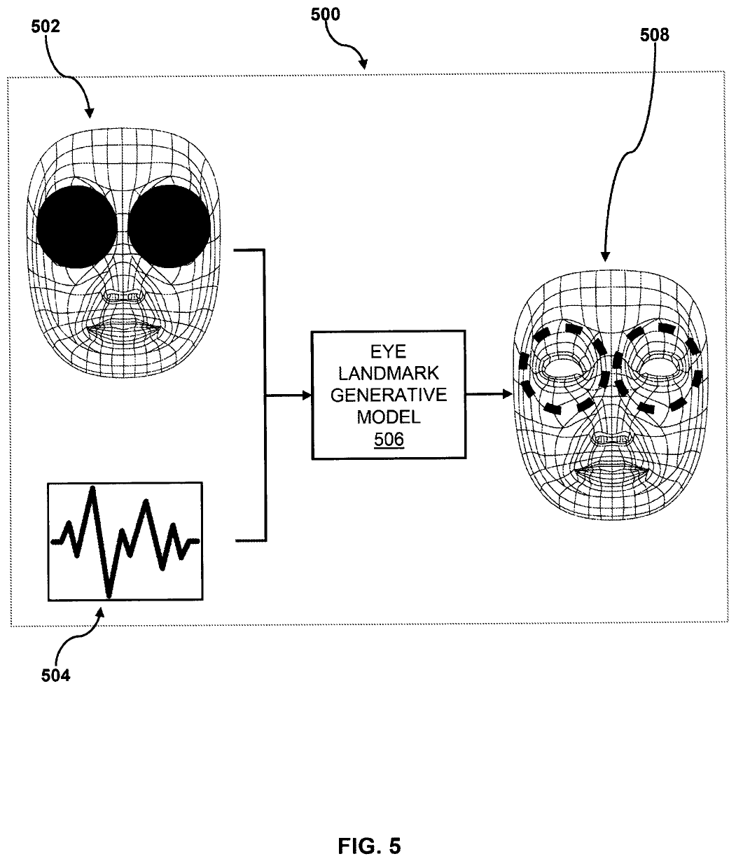

Referring now to FIG. 5, a visual representation of an eye landmark inpainting process 500 is depicted according to at least one embodiment. The eye landmark inpainting process 500 may comprise a 3D face mesh model without generated 3D eye landmarks 502, a user voice audio clip 504, a trained eye landmark generative model 506, and a 3D face mesh comprising the inpainted eye region of the 3D face mesh 508. The program 200 can input the 3D face mesh model without generated 3D eye landmarks 502 and the user voice audio clip 504 into the trained eye landmark generative model 506. The trained eye landmark generative model 506 can produce the 3D face mesh comprising the inpainted eye regions of the 3D face mesh 508.

It may be appreciated that FIGS. 2 through 5 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for mixed reality, the method comprising:
receiving one or more 3D non-eye landmarks of a user;
receiving at least one voice audio of the user;
using random noise sampled with a unit normal distribution as one or more noised 3D eye landmarks for the user;
inputting the received one or more 3D non-eye landmarks of the user, the at least one voice audio of the user, and the one or more noised 3D eye landmarks for the user, into a trained eye landmark generative model;
generating one or more 3D eye landmarks for the user using the trained eye landmark generative model;
performing an iterative refinement of the one or more generated 3D eye landmarks using the trained eye landmark generative model; and
rendering the user's generated face model using a formed 3D face mesh.

2. The method of claim 1, further comprising:
training the eye landmark generative model.

3. The method of claim 1, further comprising:
forming the formed 3D face mesh by combining the one or more generated 3D eye landmarks for the user and the one or more 3D non-eye landmarks of the user.

4. The method of claim 1, further comprising:
converting the at least one received voice audio of the user to one or more spectrograms.

5. The method of claim 1, further comprising:
displaying the rendering of the user's generated face model in a mixed reality environment.

6. The method of claim 5, wherein the displayed user's generated face model in the mixed reality environment comprises the one or more generated 3D eye landmarks for the user and the one or more 3D non-eye landmarks of the user.

7. The method of claim 1, wherein the trained eye landmark generative model comprises a Transformer encoder.

8. A computer system for mixed reality, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving one or more 3D non-eye landmarks of a user;
receiving at least one voice audio of the user;
using random noise sampled with a unit normal distribution as one or more noised 3D eye landmarks for the user;
inputting the received one or more 3D non-eye landmarks of the user, the at least one voice audio of the user, and the one or more noised 3D eye landmarks for the user, into a trained eye landmark generative model;
generating one or more 3D eye landmarks for the user using the trained eye landmark generative model;
performing an iterative refinement of the one or more generated 3D eye landmarks using the trained eye landmark generative model; and
rendering the user's generated face model using a formed 3D face mesh.

9. The computer system of claim 8, further comprising:
training the eye landmark generative model.

10. The computer system of claim 8, further comprising:
forming the formed 3D face mesh by combining the one or more generated 3D eye landmarks for the user and the one or more 3D non-eye landmarks of the user.

11. The computer system of claim 8, further comprising:
converting the at least one received voice audio of the user to one or more spectrograms.

12. The computer system of claim 8, further comprising:
displaying the rendering of the user's generated face model in a mixed reality environment.

13. The computer system of claim 12, wherein the displayed user's generated face model in the mixed reality environment comprises the one or more generated 3D eye landmarks for the user and the one or more 3D non-eye landmarks of the user.

14. The computer system of claim 8, wherein the trained eye landmark generative model comprises a Transformer encoder.

15. A computer program product for mixed reality, the computer program product comprising:
one or more computer-readable tangible storage medium and program instructions stored on at least one of the one or more tangible storage medium, the program instructions executable by a processor to cause the processor to perform a method comprising:
receiving one or more 3D non-eye landmarks of a user;
receiving at least one voice audio of the user;
using random noise sampled with a unit normal distribution as one or more noised 3D eye landmarks for the user;
inputting the received one or more 3D non-eye landmarks of the user, the at least one voice audio of the user, and the one or more noised 3D eye landmarks for the user, into a trained eye landmark generative model;
generating one or more 3D eye landmarks for the user using the trained eye landmark generative model;
performing an iterative refinement of the one or more generated 3D eye landmarks using the trained eye landmark generative model; and
rendering the user's generated face model using a formed 3D face mesh.

16. The computer program product of claim 15, further comprising:
training the eye landmark generative model.

17. The computer program product of claim 15, further comprising:
forming the formed 3D face mesh by combining the one or more generated 3D eye landmarks for the user and the one or more 3D non-eye landmarks of the user.

18. The computer program product of claim 15, further comprising:
converting the at least one received voice audio of the user to one or more spectrograms.

19. The computer program product of claim 15, further comprising:
displaying the rendering of the user's generated face model in a mixed reality environment.

20. The computer program product of claim 19, wherein the displayed user's generated face model in the mixed reality environment comprises the one or more generated 3D eye landmarks for the user and the one or more 3D non-eye landmarks of the user.
